(19) United States
(12) Patent Application Publication
(10) Pub. No.: US 2019/0009629 A1
(43) Pub. Date: Jan. 10, 2019

(54) "AFW" VEHICLE SUSPENSION (VARIANTS)

(71) Applicants: Georgiy Volodymyrovych Beylin, Kiev (UA); Sergiy Yuriiovich Petrenko, Kiev (UA)

(72) Inventors: Georgiy Volodymyrovych Beylin, Kiev (UA); Sergiy Yuriiovich Petrenko, Kiev (UA)

(21) Appl. No.: 15/757,061

(22) PCT Filed: Apr. 27, 2016
(86) PCT No.: PCT/UA2016/000052

§ 371 Date: Sep. 12, 2018

(30) Foreign Application Priority Data
Sep. 22, 2015 (UA) PCT/UA2015/000089
Apr. 22, 2016 (UA) U 2016 04500

(51) Int. Cl. B60G 11/18; B60G 21/04; B60G 3/20

(52) U.S. Cl. CPC B60G 11/18; B60G 3/20; B60G 21/04

(57) ABSTRACT

The present inventions relate to structural components of vehicles, and more particularly to suspension variants of both usual cars and special higher comfort vehicles, such as ambulances, baby carriages and wheelchairs, and also the suspension with catamaran floats. The proposed suspension, which may be used in ground and water vehicles, is configured to enable automatic road clearance and body tilt adjustment depending on the condition of the roadway, sea roughness, the speed of the vehicle and the maneuver being performed. The first variant of suspension comprises a frame, four identical arms intended to be connected with the hubs of the respective motion parts, and torsion bars attached to the frame through the bearing assemblies and connected to the arms of the corresponding motion parts, where at least two torsion bars may freely rotate with a twisting angle under the load of 1-5° and form, respectively, front and rear axis, the torsion bars are installed in parallel and their centers are kinematically connected to a connecting rod mounted in such a manner to allow synchronous axial rotation of the torsion bars, the arms of one axis are attached to the ends of the corresponding torsion bars and are installed in parallel, while the arms of each side of the suspension, i.e. right or left, are oriented in opposite directions, wherein the suspension according to the invention comprises at least four torsion bars disposed in pairs in a horizontal plane, and, additionally, the main and additional movable connection arms and linear actuators that are mounted in such a manner to allow synchronous change of their lengths, while the center of each torsion bar is connected to the connecting rod via an additional connection arm, which can freely rotate on the torsion bar, all additional connection arms are parallel, identically oriented and connected with each other by appropriate rods, and the arms of the corresponding motion parts of one axis are attached to the ends of the corresponding torsion bars, installed in parallel and oriented in opposite directions towards each other. The second variant of suspension comprises a horizontally disposed frame, a steering mechanism, four identical wheel arms, each intended to be connected at one end to the hub of the corresponding wheel, and to be connected at the other end, through a bearing assembly attached to the frame, to a coupling device installed with the possibility of its free rotation, and the coupling devices form, respectively, front and rear suspension axles, the axes of the coupling devices of both axles are installed in parallel and the arms of the wheels of one axle are installed in parallel, wherein according to the invention, each coupling device of the suspension is made in the form of an elastic coupling or a rubber-strand torsion bar, each suspension axle is provided with a mechanism for changing the direction of rotation, which is connected via appropriate coupling devices to wheel arms, the housing of said mechanism is attached to the frame of the vehicle, and the axles are interconnected by a longitudinal linkage rod, the wheel arms are attached to the frame thought the rubberized bearing assemblies and are placed in the horizontal plane, with the front left and right arms oriented forward, in the direction of movement, the rear right and left arms are oriented rearward, or vice versa, the front left and right arms are oriented backward, against the direction of movement, and the rear right and left arms are oriented forward, in the direction of movement, or the front left and right arms and rear right and left arms are oriented rearward and are mounted in such a manner to allow placement of the right and left wheels of one axle on one axis, linkage arm is installed on each axis of the wheel arms with the angle 90°±30° between said linkage arm and the arm of the corresponding wheel, linkage arms are parallel and oriented identically—either upward or downward—depending on the intended purpose of the suspension and are interconnected by a longitudinal rod for synchronous rotation of the axes of the wheel arms. The invention is based on the objective to provide a suspension featuring increased off-road capability, smoothness and stability during the movement, also in off-road conditions. The objective is attained by creating conditions for automatic adjustment of clearance and body tilt, depending on the condition of the roadway, sea roughness, vehicle speed and maneuver performed by using longer wheel arms without changing the length of the wheelbase and the possibility to choose optimal mutual orientation of said arms depending on the purpose of the suspension.

The present inventions relate to structural components of vehicles, and more particularly to suspension variants of both usual cars and special higher comfort vehicles, such as ambulances, baby carriages and wheelchairs, and also the suspension with catamaran floats. The proposed suspension, which may be used in ground and water vehicles, is configured to enable automatic road clearance and body tilt adjustment depending on the condition of the roadway, sea roughness, the speed of the vehicle and the maneuver being performed.

The suspension according to the invention, when used in a catamaran structure, enables to significantly reduce the amplitude of rocking on waves compared to a catamaran of the prior art, and thus increase resistance to overturning and attain greater speeds of movement.

AFW is an abbreviation of the slogan: “always on four wheels”.

Clearance or road clearance is the distance from the ground to the lowest point in the central part of a terrestrial vehicle. Under certain road speed and roadway condition, a motor vehicle steerability depends on the clearance value.

The suspension or spring system of a vehicle is a combination of parts, assemblies and mechanisms that play the role of a connecting link between the vehicle body and the road.

In the present application the motion parts are the wheels of the ground vehicle or floats of the vessels, i.e. catamarans.

In terms of a number of the essential features, the closest analogue of the variants of the present invention is a vehicle suspension comprising a frame, four identical arms intended to be connected with the hubs of the respective motion parts, and torsion bars attached to the frame through the bearing assemblies and connected to the arms of the corresponding motion parts, where at least two torsion bars may freely rotate with a twisting angle under the load of 1-5° and form, respectively, front and rear axis, the torsion bars are installed in parallel and their centers are kinematically connected to a connecting rod mounted in such a manner to allow synchronous axial rotation of the torsion bars, the arms of one axis are attached to the ends of the corresponding torsion bars and are installed in parallel, while the arms of each side of the suspension, i.e. right or left, are oriented in opposite directions [Patent for Utility Model No. 92122, Ukraine, IPC (2014.01) B6OG 99/00; B6OG 21/00; published: 25.07.2014, bul. # 14].

This design ensures a continuous, even distribution of the vehicle weight on all four wheels by maintaining a constant coefficient of traction with a roadway for all wheels, which, in the case of a small difference in heights of adjacent sections of the road (up to 15-20 cm), does not depend on the curvature of the roadway, and it also enables a body tilt in the direction of the turn during the movement, thus decreasing the likelihood of the vehicle skidding.

However, the described suspension does not provide the required smoothness and stability during movement, as it does not enable changing the clearance depending on the condition of the roadway and the speed of the vehicle. This statement is based on the fact that the length of the suspension arms is limited and depends on the wheelbase. In addition, the difference in the movement trajectories of one axis wheels may result in destabilization of the body position at high torque values. Also, in said suspension design, the connection of the wheels and the transmission is complicated. Therefore, the variants of the present invention are based on the objective to provide such a suspension of a ground vehicle or catamaran that would provide increased stability and smoothness of movement of ground vehicles on highways, ordinary roads, and off-road conditions, as well as for catamarans on floats in the sea.

In the first variant of the suspension the objective is attained due to the possibility of automatic adjustment of the ground vehicle's clearance, depending on the condition of the roadway, the speed of movement, and the height adjustment of a catamaran bridge above the water surface, depending on the sea roughness within 1-4 points, without change of the wheelbase of a ground vehicle or a catamaran float base, respectively, and the width of a vehicle by creating conditions for synchronous change in the mutual position of the arms connected with hubs of the corresponding motion parts, with the possibility of maintaining the total length of said arms within the vehicle dimensions.

In the second variant of the suspension the objective is attained by creating conditions for automatic adjustment of clearance and body tilt, depending on the condition of the roadway, sea roughness, vehicle speed and maneuver performed by using longer wheel arms without changing the length of the wheelbase and the possibility to choose optimal mutual orientation of said arms depending on the purpose of the suspension.

Similar to a vehicle suspension of the prior art, the vehicle suspension according to the first variant of the present invention comprises a frame, four identical arms intended to be connected with the hubs of the respective motion parts, and torsion bars attached to the frame through the bearing assemblies and connected to the arms of the corresponding motion parts, where at least two torsion bars may freely rotate with a twisting angle under the load of 1-5° and form, respectively, front and rear axis, the torsion bars are installed in parallel and their centers are kinematically connected to a connecting rod mounted in such a manner to allow synchronous axial rotation of the torsion bars, the arms of one axis are attached to the ends of the corresponding torsion bars and are installed in parallel, while the arms of each side of the suspension, i.e. right or left, are oriented in opposite directions, wherein the suspension according to the invention comprises at least four torsion bars disposed in pairs in a horizontal plane, and, additionally, the main and additional movable connection arms and linear actuators that are mounted in such a manner to allow synchronous change of their lengths, while the center of each torsion bar is connected to the connecting rod via an additional connection arm, which can freely rotate on the torsion bar, all additional connection arms are parallel, identically oriented and connected with each other by appropriate rods, and the arms of the corresponding motion parts of one axis are attached to the ends of the corresponding torsion bars, installed in parallel and oriented in opposite directions towards each other.

A feature of the suspension according to the first variant is that the connecting rod is provided with a mechanism for changing its length. Similar to a vehicle suspension of the prior art, the vehicle suspension according to the second variant of the present invention comprises a horizontally disposed frame, a steering mechanism, four identical wheel arms, each intended to be connected at one end to the hub of the corresponding wheel, and to be connected at the other end, through a bearing assembly attached to the frame, to a coupling device installed with the possibility of its free rotation, and the coupling devices form, respectively, front and rear suspension axles, the axes of the coupling devices of both axles are installed in parallel and the arms of the wheels of one axle are installed in parallel, wherein according to the invention, each coupling device of the suspension is made in the form of an elastic coupling or a rubber-strand torsion bar, each suspension axle is provided with a mechanism for changing the direction of rotation, which is connected via appropriate coupling devices to wheel arms, the housing of said mechanism is attached to the frame of the vehicle, and the axles are interconnected by a longitudinal linkage rod, the wheel arms are attached to the frame thought the rubberized bearing assemblies and are placed in the horizontal plane, with the front left and right arms oriented forward, in the direction of movement, the rear right and left arms are oriented rearward, or vice versa, the front left and right arms are oriented backward, against the direction of movement, and the rear right and left arms are oriented forward, in the direction of movement, or the front left and right arms and rear right and left arms are oriented rearward and are mounted in such a manner to allow placement of the right and left wheels of one axle on one axis, linkage arm is installed on each axis of the wheel arms with the angle 90°±30° between said linkage arm and the arm of the corresponding wheel, linkage arms are parallel and oriented identically—either upward or downward—depending on the intended purpose of the suspension and are interconnected by a longitudinal rod for synchronous rotation of the axes of the wheel arms.

A feature of the suspension according to the second variant is that the housing of the mechanism for changing the direction of rotation is rigidly attached to the vehicle frame.

Another feature of the suspension according to the second variant is that housing of the mechanism for changing the direction of rotation is attached to the frame in such a manner to allow its rotation on the axle axis to change the vehicle suspension clearance.

Also, a feature of the suspension according to the second variant is that it is provided with a control system designed to change the length of the longitudinal rod that connects the linkage arms and contains an on-board computer and sensors of acceleration and tilt of the frame with the outputs of said sensors connected to the corresponding inputs of the computer, while the on-board computer output is connected to the linear actuator mover, which connects the free ends of the longitudinal rod.

Both variants of the suspension of the present invention are multi-arm suspensions designed to ensure an even distribution of the vehicle's weight among all four motion parts during its movement, while maintaining a constant coefficient of traction for all motion parts, where said coefficient does not depend on the curvature of the roadway or sea roughness and the suspension, in contrast to the suspension-prototype, has an adjustable clearance. Suspension can enable the body tilt while driving along the slope, at turns and at the time of passengers' exit.

Unlike the first variant of the suspension, the second variant has longer wheel arms without changing the length of the wheelbase. The suspension provides for repeatability of identical rotation trajectories for the wheels of one axis. In addition, the second variant of the suspension provides three options for mutual orientation of the wheel arms, allowing to choose and apply their optimum position, depending on the intended purpose of the suspension, which enables to increase the cross-country ability of the vehicle in off-road conditions. In the first variant of the suspension, for the purpose of clearance adjustment an additional movable connection arm and a linear actuator are installed on each torsion bar. The connection rods are attached to the movable arms. Meanwhile, a stationary (relative to the torsion bar) connection arm is fixed to the torsion bar and forms an angle of 50°±10° with the wheel arm. The linear actuator is installed between the movable and stationary arms with the possibility to change their mutual position by rotating the corresponding torsion, and synchronous and identical changes of the length of the linear actuators automatically increase or decrease the suspension's clearance.

The vehicle suspension of the invention can be supplemented by a conventional steering mechanism. For the purpose of reinforcement, the suspension may be designed according to a parallelogram principle by way of supplementing it with an additional arm.

In addition to the aforementioned, it should be noted that in a ground vehicle suspension of the prior art the sum of the arms lengths may not exceed 70% of the width of the vehicle due to the presence of the transmission and the width of the wheels. For the modern vehicles proportions (length to width ratios), the suspension variants according to the invention allow to use the wheel arms with a total length equal to 110-130% of the vehicle width, which enables to increase the range of clearance adjustment.

In the second variant of the suspension the arms of the wheels of one axis have a mechanical connection. Each of the arms is aligned with a gear mechanism for changing the direction of rotation via an elastic coupling or a rubber-strand torsion, which enables movement of one of wheel arms up, while the other one moves down. To change the clearance, the housing of each gear mechanism for changing the direction of rotation is aligned with an additional linkage arm and a linear actuator. The linear actuator is installed between the additional arm and the frame, which makes it possible to rotate the housing of the gear mechanism for changing the direction of rotation. Synchronous and identical change of the length of linear actuators increases or decreases the suspension clearance. Meanwhile, the length of the longitudinal rod changes proportionally and synchronously, which ensures the stability of the suspension state.

Thus, both variants of the suspension of the invention allow tilts of the vehicle body while driving along the slope, at turns and at the time of passengers' exit, but the second variant of the suspension additionally provides the increased smoothness of off-road movement compared to the first variant. However, the cost of the first variant of the suspension is less than the cost of the second variant of the suspension.

At the time of patent information research performed in the process of the present application preparation the authors have not revealed any vehicle suspensions possessing the above mentioned set of essential features, which proves that the claimed technical solutions comply with “novelty” patentability criterion. The technical result obtained as a result of the implementation of the first variant of the invention is the possibility to automatically adjust the ground vehicle's clearance, depending on the condition of the roadway, the speed of movement, and to adjust height of a catamaran bridge above the water surface, depending on the sea roughness within 1-4 points, without change of the wheelbase of a ground vehicle or a catamaran float base, respectively, and the width of a vehicle by creating conditions for synchronous change in the mutual position of the arms connected with hubs of the corresponding motion parts, with the possibility of maintaining the total length of said arms within the vehicle dimensions.

The technical result obtained as a result of the implementation of the second variant of the invention is the possibility to create conditions for repeating the same rotation trajectories of the wheels of one axis and availability of three variants of mutual orientation of the wheel arms, which allows choosing and applying their optimum position depending on the intended purpose of the suspension, thus, ensuring smoother off-road ride compared to the first variant of the suspension.

The authors have not revealed the indicated technical result in the known technical solutions of the prior art, therefore the variants of the proposed suspension may be deemed to comply with the “inventive step” patentability criterion.

The variants of the proposed vehicle suspension consist of structural elements, which may be manufactured using presently known technological methods, means and materials. They may be used in ground vehicles, aircraft chassis, and the notion parts (floats) of a catamaran, i.e. in different sectors of economy, therefore it is possible to conclude that the proposed solutions comply with “industrial applicability” patentability criterion.

The essence of the inventions is further explained by the drawings, where:

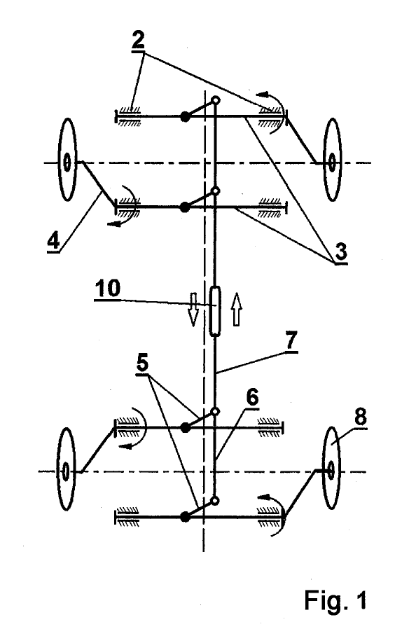

FIG. 1 is a kinematic diagram of the first variant of the suspension.

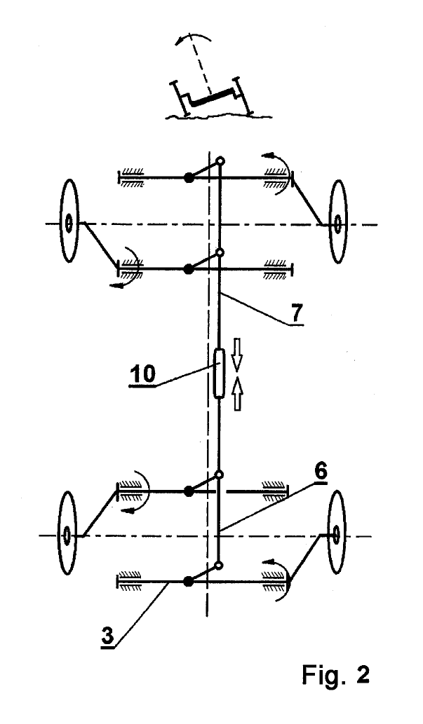

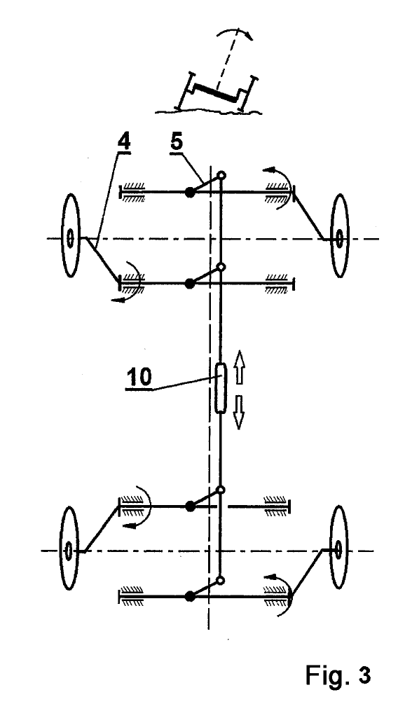

FIGS. 2 and 3 illustrates the process of tilting the vehicle body, suing the first variant of the suspension variant, to the right or to the left by changing the length of the connecting rod.

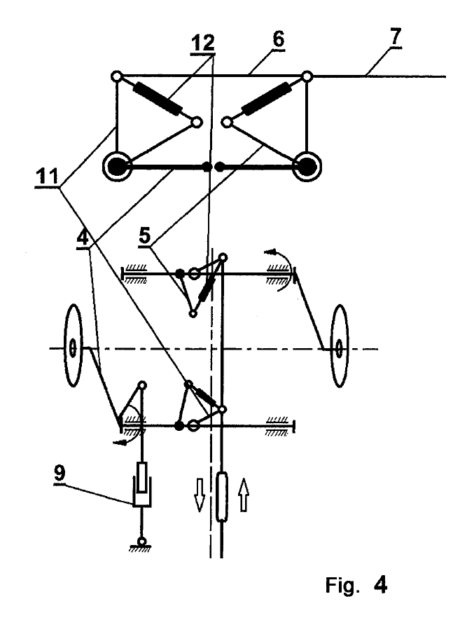

FIG. 4 shows the first variant of the suspension with linear actuators in a ready-to-operate condition, where the arms of the front and rear axles are in a strictly horizontal position.

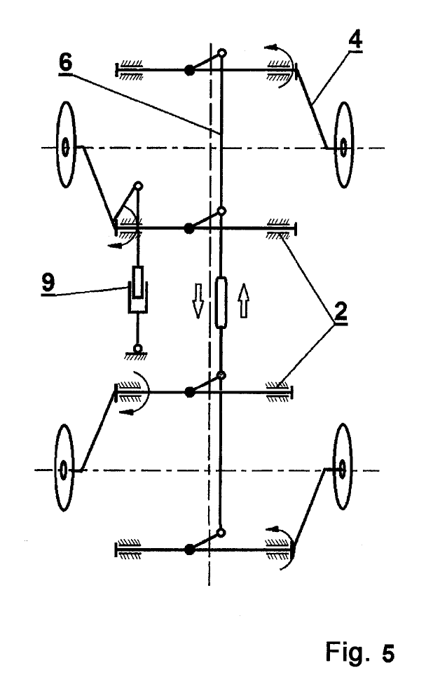

FIGS. 5, 12 show the first variant of the suspension with longer wheel arms for increasing the clearance in order to enable the vehicle to overcome the obstacles.

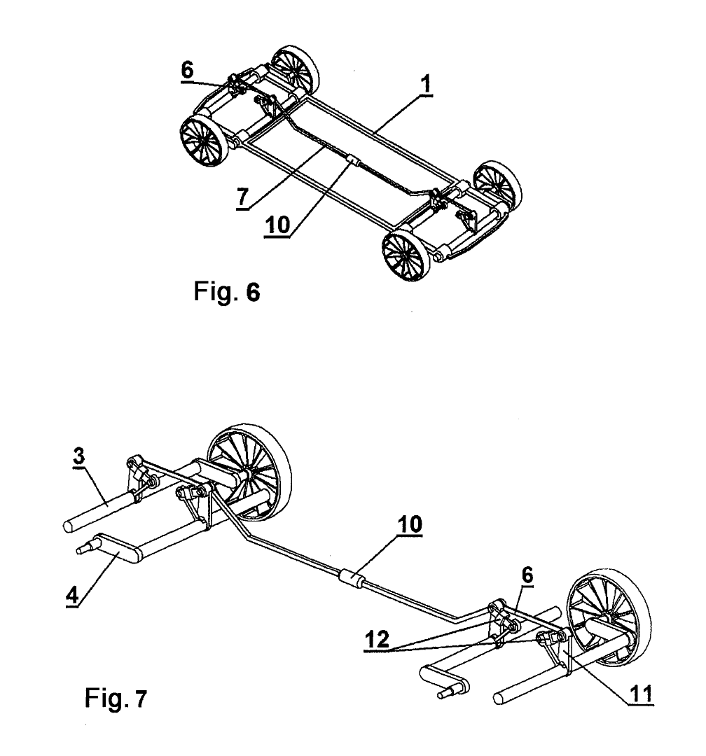

FIG. 6 is a general view of the first variant of the suspension.

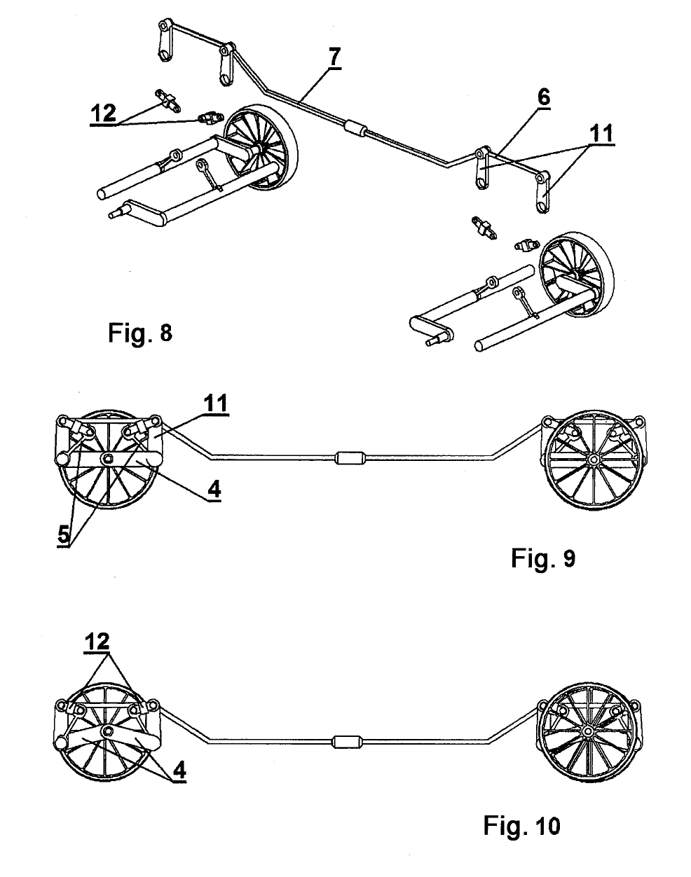

FIGS. 7, 8 show individual elements of the first variant of the suspension.

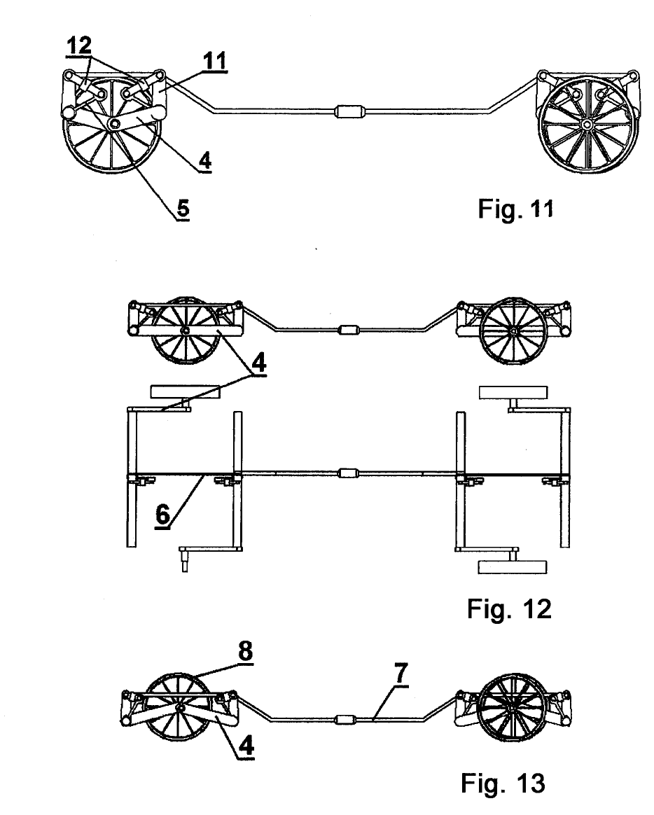

FIGS. 9, 10, 11 show the position of the additional connection arms of the first variant of the suspension at different clearance values.

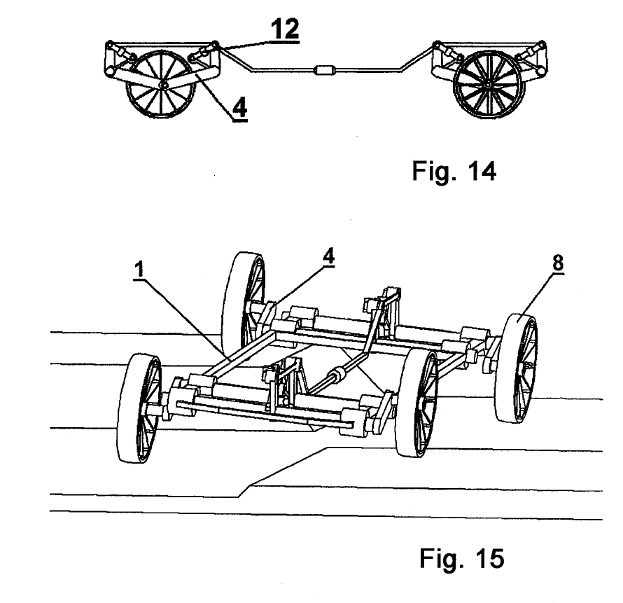

FIGS. 12, 13, 14 show the position of the additional connection arms of the first variant of the suspension at different clearance values and with increased sizes of the wheel arms.

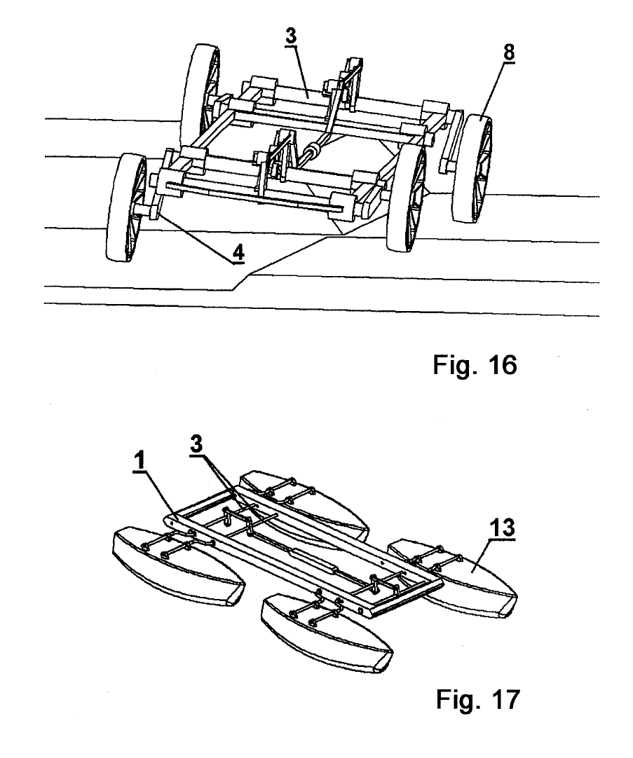

FIGS. 15, 16 show the process of overcoming obstacles by the vehicle with the first variant of suspension with different sizes of wheel arms.

FIG. 17 shows the first variant of the suspension for a vessel, i.e. a catamaran.

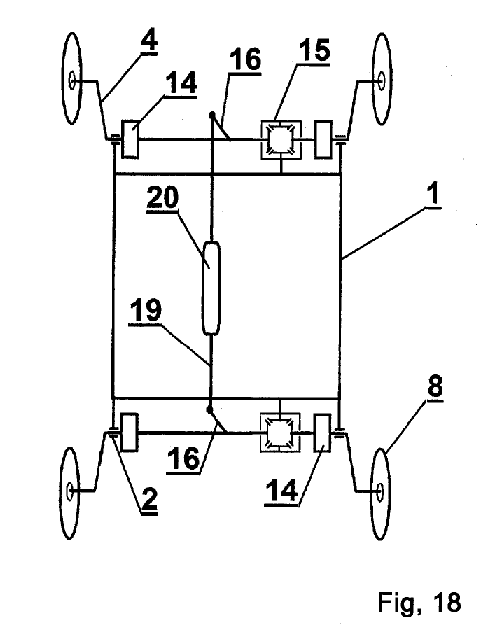

FIG. 18 is a kinematic diagram of the second variant of the suspension.

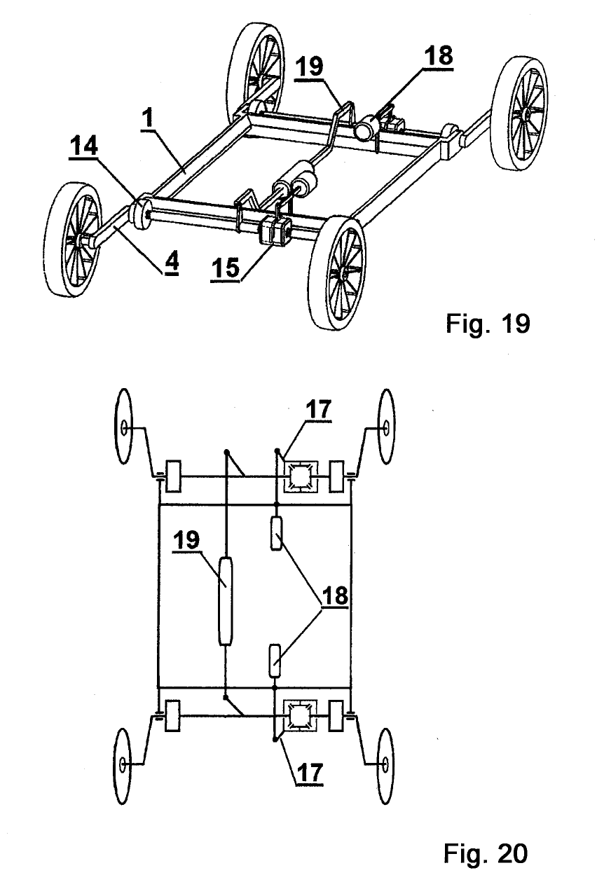

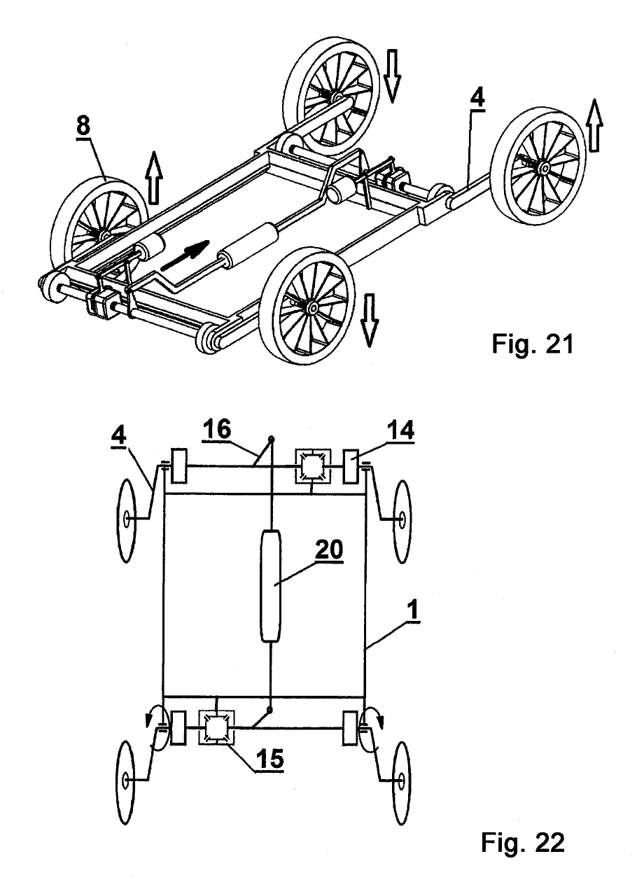

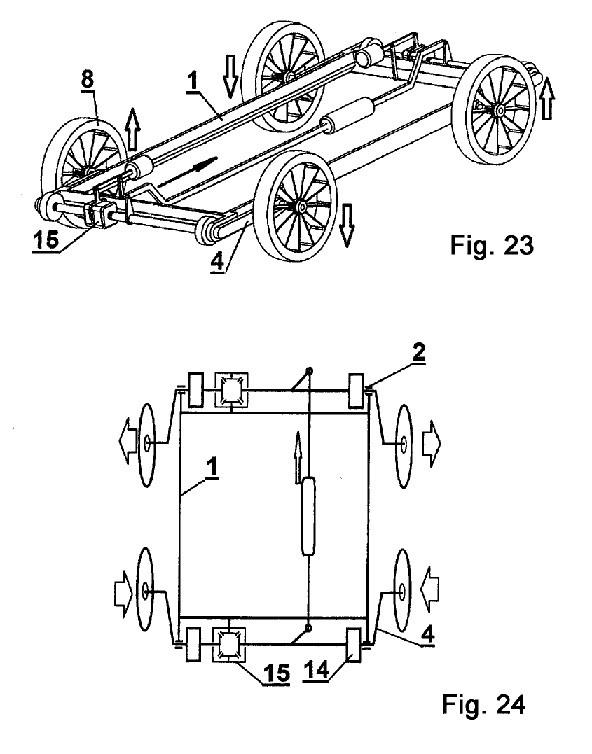

FIGS. 19, 21, 23 show variants of mutual orientation of the wheel arms in the second variant of suspension.

FIGS. 20, 22, 24 are the kinematic schemes of the suspensions according to the second variant with different mutual orientations of the wheel arms.

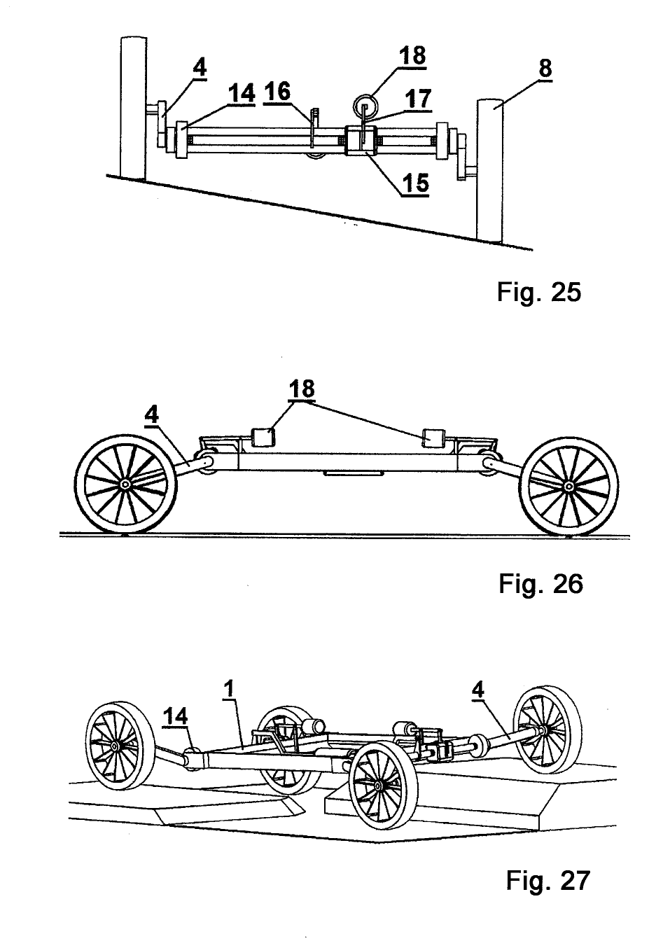

FIG. 25 shows the operation of the second variant of suspension in case of body tilt.

FIG. 26 shows the operation of the second variant of suspension in case of clearance adjustment.

FIG. 27 shows the operation of the second variant of suspension during overcoming complex obstacles.

The first variant of the vehicle suspension comprises a frame 1 with rubberized bearing assemblies 2 attached thereon, four torsion bars 3 with four arms 4 attached to them, four main connection arms 5, connecting rods 6 and 7, and four wheels 8. In the suspension, shock absorbers 9 may be installed for each wheel 8. The connecting rod 7 is equipped with a mechanism 10 for changing its length. For the purpose of clearance adjustment, the suspension is provided with additional movable connection arms 11, which are mounted in a manner to allow their free rotation on the torsion bar 3, as well as with linear actuators 12. Four identical wheel arms 4 are designed to connect to the hubs of the corresponding wheels 8. Torsion bars 3 are mounted in a manner to allow their free rotation with a twisting angle under a load of 1-5°, and they form, respectively, the front and rear axles. Torsion bars 3 are disposed in pairs in a horizontal plane. One end of each torsion bar 3 is connected by the arm 4 to the hub of the corresponding wheel 8 and the other end may freely rotate in the support on the frame 1. The center of each torsion bar 3 is connected to the connecting rod 7 via a main connection arm 5, which is freely rotatable on the torsion bar 3. All the main connection arms 5 are parallel and identically oriented. Each torsion bar 3 is provided with an additional movable connection arm 11 mounted in a manner to allow free rotation on the torsion bar 3 and with a linear actuator 12. The linear actuator 12 is mounted between the movable and stationary connection arms 11 with the possibility of changing the angle between them. The arms 4 of the wheels 8 of one axis are attached to the ends of the corresponding torsion bars 3, are installed in parallel and are oriented in opposite directions, towards each other. The connecting rod 7 is provided with a mechanism for changing its length 10, which is connected to a control unit (on-board computer) (not shown), or can be provided with a double-sided spring damper (not shown). A vehicle with the suspension of the proposed structure also comprises a control system including a control unit (on-board computer), acceleration and tilt sensors (not shown) connected to the corresponding inputs of the control unit, an also an actuator mechanism of the steering arm (not shown) connected to the output of the control unit.

When constructing a catamaran based on the vehicle suspensions according to the invention, four floats 13 are installed instead of four wheels 8.

Similar to the first variant of the suspension, its second variant comprises a horizontally disposed frame 1 with rubberized bearing assemblies 2 attached thereon and four identical wheel arms 4. The wheel arms 4 of the second variant of the suspension according to the invention are connected through elastic couplings 14 to a gear mechanism for changing the direction of rotation 15 of the linkage arms 16 and 17, the linear actuators for changing the clearance 18, the longitudinal rod 19, and the wheels 8. Rubber-strand torsions may be used instead of elastic couplings 14 for connecting the wheel arms 4 with the gear mechanism for changing the direction of rotation 15, as their load-carrying capacity is higher than that of the elastic couplings. The longitudinal rod 19 is equipped with a mechanism for changing its length, i.e. a linear actuator 20.

The suspension is also provided with a conventional steering mechanism (not shown), a control system (not shown) intended to change the length of the longitudinal rod 19 that connects the linkage arms 16 and 17 and comprises an on-board computer and sensors to detect speed, steering positions, acceleration and frame tilt (not shown). The outputs of the speed, steering position, acceleration and frame tilt sensors are connected to the corresponding inputs of the computer, while the output of the on-board computer is connected to the linear actuator drive (not shown), which connects the free ends of the longitudinal rod 19. The on-board computer may be a usual industrial controller with the appropriate software. The first variant of the vehicle suspension operates as follows.

At the assembling stage, for proper operation of the suspension, all connection arms are installed in parallel and identically oriented either upward or downward, depending on the intended purpose of the suspension. In addition, the length of the connecting rod 6 is set such that the arms 4 of the front and rear axles occupy a horizontal position (FIG. 4). The torsion bars 3 (FIGS. 1, 7, 8) can freely rotate during the movement of the arm 4 when the wheel 8 of one axle rolls over an obstacle. Due to the rubberized bearing assemblies 2, rolling of wheel 8 of one axle on the obstacle results in change in the position of the main connection arms 5 connected by the connecting rod 7 and also in change of the spatial position of the frame 1, and therefore, due to gravity the vehicle suspension self-aligns and evenly distributes its weight among the four wheels 8, being four points of support. In this case, the frame 1 takes the position of the averaged plane for the four points of wheels 8 contact with the road (FIGS. 15, 16).

The authors have experimentally established that the performance of the suspension is maintained if the biggest difference in the heights of the installation of the wheels 8 does not exceed 0.7 times the sum of the arms 4 lengths. The suspension overcomes small obstacles due to axial twisting of torsion bars 3 with a small twisting angle of 1-5° . In addition, this suspension allows tilting a body in the direction of turn to prevent skidding. Thus, by changing the length of the connecting rod 7, it is possible to tilt the frame 1 with the vehicle body to the right or to the left (FIGS. 2, 3) to ensure contact with the surface of the road (ground) when moving along a slope, cornering, or when passengers enter or exit the vehicle. The tilt is effected by the mechanism of changing the length 10. The synchronous and identical change in the length of the linear actuators 12 alters the mutual position of the arms 4 and 11 thus, respectively, increasing or decreasing the suspension clearance (FIGS. 4, 9, 10, 11). To increase the clearance and the height of obstacles that the vehicle can overcome, the length of the arms 4 can be increased without changing the wheelbase (FIGS. 5, 12, 13, 14, 16).

The first variant of the suspension according to the invention in a catamaran structure operates similar to a suspension of a ground vehicle. The change in clearance enables the vessel to overcome higher waves. The deck tilt during turns allows to prevent lateral sliding.

The second variant of the vehicle suspension of the invention operates as follows. At the assembling stage, for proper operation of the suspension, the length of the longitudinal rod 19 is set such that the wheel arms 4 of the front and rear axles occupy a horizontal position.

Due to gravity the vehicle suspension self-aligns and evenly distributes its weight among four wheels 8, being four points of support. The wheel arms 4 (FIGS. 18, 19) are able to rotate freely during movement thanks to rubberized bearing assemblies 2. When a wheel 8 of one axle rolls over an obstacle, the position of the linkage arms 16 connected to the longitudinal rod 19 changes and the spatial position of the frame 1 changes. During cornering or traveling along the slope, speed, steering position, frame tilt and acceleration sensors transmit the tilt angle value to the on-board computer, which accordingly changes the length of the longitudinal rod 19 using the linear actuator 20, and due to gravity the vehicle suspension self-aligns and evenly distributes its weight among the four wheels 8. In this case, the frame 1 takes the position of the averaged plane for the four points of wheels 8 contact with the road. The authors have experimentally established that the performance of the suspension is maintained if the biggest difference in the heights of the installation of the wheels 8 does not exceed 0.7 times the sum of the arms 4 lengths. The suspension overcomes small obstacles due to using elastic couplings 14 with a small twisting angle of 1-5°.

In addition, this suspension allows tilting a body in the direction of turn to prevent skidding. Thus, by changing the length of the rod 19, it is possible to tilt the frame 1 with the vehicle body to the right or to the left (FIG. 25) to ensure contact with the surface of the road (ground) when moving along a slope, cornering, or when passengers enter or exit the vehicle. The tilt is effected by the mechanism of changing the length of the longitudinal rod 19, i.e. the linear actuator 20, having its drive connected to the corresponding output of the on-board computer.

The synchronous and identical change in the length of the linear actuators 18 and also the linear actuator 20 alters the mutual position of the arms 17, 4 and frame 1 thus, respectively, increasing or decreasing the suspension clearance (FIG. 26). To increase the clearance and the height of obstacles that the vehicle can overcome, the length of the arms 3 can be increased without changing the wheelbase.

The suspension has three variants of mutual orientation of the wheel arms 3 and allows to choose their optimum position depending on the intended purpose of the suspension (FIGS. 20, 22, 24). The vehicle suspension of the invention can be used in ambulances, baby carriages and wheelchairs, providing increased comfort and high reliability, since the puncture of one wheel 8 tire during the movement of the vehicle practically does not affect the steerability—the vehicle always stays on four wheels 8, which contact the road (ground).

Contacting the road (ground) with all four wheels 8 simultaneously with a uniform distribution of the vehicle weight is achieved without use of elastic elements, but only due to the gravity and kinematic connection of the suspension structural elements with each other.

### LIST OF ITEMS IN THE DRAWINGS

1—frame
2—rubberized bearing assemblies attached to the frame
3—torsion bars
4—wheel arms
5—main arms
6, 7—connecting rods 6 and 7
8—wheels
9—shock absorbers of wheels
10—mechanism for changing the length of the connecting rod 7
11—additional movable arms
12—linear actuators
13—catamaran floats
14—elastic coupling or rubber-strand torsion bar
15—gear mechanism for changing the direction of rotation
16, 17—linkage arms
18—linear actuator for changing clearance
19—longitudinal rod
20—the mechanism for changing the length of the rod 19—linear actuator.

1. A vehicle suspension comprising a frame, four identical arms intended to be connected with the hubs of the respective motion parts, and torsion bars attached to the frame through the bearing assemblies and connected to the arms of the corresponding motion parts, where at least two torsion bars may freely rotate with a twisting angle under the load of 1-5° and form, respectively, front and rear axis, the torsion bars are installed in parallel and their centers are kinematically connected to a connecting rod mounted in such a manner to allow synchronous axial rotation of the torsion bars, the arms of one axis are attached to the ends of the corresponding torsion bars and are installed in parallel, while the arms of each side of the suspension, i.e. right or left, are oriented in opposite directions, wherein the suspension comprises at least four torsion bars disposed in pairs in a horizontal plane, and, additionally, the main and additional movable connection arms and linear actuators that are mounted in such a manner to allow synchronous change of their lengths, while the center of each torsion bar is connected to the connecting rod via an additional connection arm, which can freely rotate on the torsion bar, all additional connection arms are parallel, identically oriented and connected with each other by appropriate rods, and the arms of the corresponding motion parts of one axis are attached to the ends of the corresponding torsion bars, installed in parallel and oriented in opposite directions towards each other.

2. The vehicle suspension according to claim 1, wherein the connecting rod is provided with a mechanism for changing its length.

3. A vehicle suspension comprising a horizontally disposed frame, a steering mechanism, four identical wheel arms, each intended to be connected at one end to the hub of the corresponding wheel, and to be connected at the other end, through a bearing assembly attached to the frame, to a coupling device installed with the possibility of its free rotation, and the coupling devices form, respectively, front and rear suspension axles, the axes of the coupling devices of both axles are installed in parallel and the arms of the wheels of one axle are installed in parallel, wherein each coupling device of the suspension is made in the form of an elastic coupling or a rubber-strand torsion bar, each suspension axle is provided with a mechanism for changing the direction of rotation, which is connected via appropriate coupling devices to wheel arms, the housing of said mechanism is attached to the frame of the vehicle, and the axles are interconnected by a longitudinal linkage rod, the wheel arms are attached to the frame thought the rubberized bearing assemblies and are placed in the horizontal plane, with the front left and right arms oriented forward, in the direction of movement, the rear right and left arms are oriented rearward, or vice versa, the front left and right arms are oriented backward, against the direction of movement, and the rear right and left arms are oriented forward, in the direction of movement, or the front left and right arms and rear right and left arms are oriented rearward and are mounted in such a manner to allow placement of the right and left wheels of one axle on one axis, linkage arm is installed on each axis of the wheel arms with the angle 90°±30° between said linkage arm and the arm of the corresponding wheel, linkage arms are parallel and oriented identically—either upward or downward—depending on the intended purpose of the suspension and are interconnected by a longitudinal rod for synchronous rotation of the axes of the wheel arms.

4. The vehicle suspension according to claim 3, wherein the housing of the mechanism for changing the direction of rotation is rigidly attached to the vehicle frame.

5. The vehicle suspension according to claim 3, wherein the housing of the mechanism for changing the direction of rotation is attached to the frame in such a manner to allow its rotation on the axle axis to change the vehicle suspension clearance.

6. The vehicle suspension according to claim 3, wherein it is provided with a control system designed to change the length of the longitudinal rod that connects the linkage arms and contains an on-board computer and sensors of acceleration and tilt of the frame with the outputs of said sensors connected to the corresponding inputs of the computer, while the on-board computer output is connected to the linear actuator mover, which connects the free ends of the longitudinal rod.
